(19) United States
(12) Patent Application Publication
(10) Pub. No.: US 2018/0174215 A1
(43) Pub. Date: Jun. 21, 2018

(54) Shopping Cart with Assistance Unit

(71) Applicant: Wal-Mart Stores, Inc., Bentonville, AR (US)

(72) Inventors: Fernando Israel Medina, Bentonville, AR (US); Steven Jackson Lewis, Bentonville, AR (US); Nicholaus Adam Jones, Fayetteville, AR (US)

(21) Appl. No.: 15/846,471

(22) Filed: Dec. 19, 2017

Related U.S. Application Data
(60) Provisional application No. 62/437,286, filed on Dec. 21, 2016.

(51) Int. Cl. G06Q 30/06

(52) U.S. Cl. CPC G06Q 30/0613; G06K 17/0022; G06Q 30/0639

(57) ABSTRACT

An example shopping cart is described. The example shopping cart includes a frame, a basket portion mounted to the frame, two or more wheels mounted to the frame for transporting the shopping cart within a geographic area, and an assistance unit mounted to the frame. The assistance unit includes a radio-frequency identification tag configured to transmit a signal for receipt by a radio-frequency identification reader. The assistance unit includes an actuator configured to be selectively actuated between a first position that prevents the radio-frequency identification tag from transmitting the signal from the assistance unit and a second position that facilitates transmissions of the signal from the assistance unit.

### CROSS-REFERENCE TO RELATED APPLICATIONS

This application claims the benefit of co-pending, commonly assigned U.S. Provisional Patent Application No. 62/437,286, which was filed on Dec. 21, 2016. The entire content of the foregoing provisional patent application is incorporated herein by reference.

### BACKGROUND

Shopping carts are configured to be transported through a facility by a user. Conventionally shopping carts have not included additional features, such as electronics that would improve the user's experience or provide the user with a mechanism for interacting with or communicating with others in the facility (e.g., to request assistance).

### SUMMARY

Exemplary embodiments of the present disclosure provide a shopping cart with an assistance unit. The assistance unit can be activated to communicate a request for assistance from the user of the shopping cart and can be deactivated when the user is not requesting assistance. The assistance unit allows the user to continue through a facility while an associate in the facility locates the shopping cart from which the communication of the request was transmitted. In particular, the assistance unit can include a radio-frequency identification (RFID) tag that transmits a signal for receipt by an RFID reader. The assistance unit further includes an actuator that can be selectively actuated by the user between a first position that prevents the RFID tag from transmitting the signal (e.g., prevents the RFID reader from reading the RFID tag) and a second position that facilitates transmission of the signal from the RFID tag (e.g., allows the RFID reader to read the RFID tag). Based on the received signal from the RFID tag, the appropriate associate can locate the shopping cart within the facility to provide assistance to the user of the shopping cart. The user can therefore continue moving through the facility while the appropriate assistance locates the shopping cart without losing time waiting on the associate.

In accordance with embodiments of the present disclosure, an exemplary shopping cart with assistance unit is provided. The shopping cart includes a frame, a basket portion, two or more wheels, and an assistance unit. The basket portion can be mounted to the frame. The two or more wheels can be mounted to the frame for transporting the shopping cart within a geographic area. The assistance unit can be mounted to and/or integrated with the frame. The assistance unit can include a radio-frequency identification tag configured to transmit a signal for receipt by a radio-frequency identification reader. The assistance unit includes an actuator configured to be selectively actuated between a first position that prevents the radio-frequency identification tag from transmitting the signal from the radio-frequency identification tag (e.g., prevents the RFID reader from reading the RFID tag) and a second position that facilitates transmissions of the signal from the radio-frequency identification tag (e.g., allows the RFID reader to read the RFID tag).

In one embodiment, the assistance unit includes a housing configured to contain therein the radio-frequency identification tag and the actuator. In one embodiment, the assistance unit includes a lifting assembly such that actuating the actuator into the second position at least partially lifts the RFID tag out of the housing with the lifting assembly to improve the signal range of the RFID tag. In one embodiment, the actuator can be a panel that is slidable between the first position and the second position. In the second position, the panel exposes a window in the housing through which the signal from the radio-frequency identification tag is transmitted. In the first position, the panel covers the window in the housing to prevent the signal from the radio-frequency identification tag from being transmitted out of the housing. The housing and the panel can be formed of an electromagnetic shielding material.

In one embodiment, the radio-frequency identification tag can be a passive radio-frequency identification tag, and the actuator prevents transmission of the signal by the radio-frequency identification tag in the first position by shielding the radio-frequency identification tag from transmissions emitted by the radio-frequency identification reader. In one embodiment, the actuator includes a switch, and actuating the actuator into the second position creates an electrical contact sufficient to permit the radio-frequency identification tag to transmit the signal to the radio-frequency reader.

In one embodiment, the radio-frequency identification tag can be a near-field radio-frequency identification tag, and the actuator includes a far-field component. Actuation of the actuator into the second position places the near-field radio-frequency identification tag into operable proximity of the far-field component, and the near-field radio-frequency identification tag transmits the signal to the radio-frequency receiver via the far-field component. The far-field component can include a far-field antenna.

In one embodiment, the shopping cart can include a visual indicator mounted to the frame or the basket portion. The visual indicator provides visual feedback when the actuator is actuated into the second position. In one embodiment, the visual indicator can be in the form of a flag. The visual indicator can include one or more light emitting diodes (LEDs) for providing the visual feedback. The radio-frequency identification tag can include a unique identifier (e.g., a unique, alphanumeric identification number).

In accordance with embodiments of the present disclosure, an exemplary shopping cart system is provided. The shopping cart system includes one or more radio-frequency identification readers, and one or more shopping carts. The radio-frequency identification reader(s) can be disposed within a geographic area. The shopping cart(s) can be disposed within the geographic area. Each shopping cart includes a frame, a basket portion, two or more wheels, and an assistance unit. The basket portion can be mounted to the frame. The two or more wheels can be mounted to the frame for transporting the shopping cart within the geographic area. The assistance unit can be mounted to the frame and includes a radio-frequency identification tag and an actuator. The radio-frequency identification tag can be configured to transmit a signal for receipt by the radio-frequency identification reader. The actuator can be configured to be selectively actuated between a first position that prevents the radio-frequency identification tag from transmitting the signal from the radio-frequency identification tag and a second position that facilitates transmissions of the signal from the radio-frequency identification tag.

Based on the signal from the radio-frequency identification tag, the radio-frequency identification reader(s) that receive the signal can be used to identify a first geographic position and a second geographic position of the shopping cart within the geographic area. The first geographic position and the second geographic position of the shopping cart can be transmitted to a portable electronic device. The first geographic position of the shopping cart can correspond with a position of the shopping cart within the geographic area when the actuator was initially actuated into the second position. The second geographic position of the shopping cart can correspond with a current geographic position of the shopping cart within the geographic area.

The shopping cart system can include a plurality of radio-frequency identification readers disposed within the geographic area. The plurality of radio-frequency identification readers can track a geographic position of the shopping cart within the geographic area after the actuator has been actuated into the second position. The shopping cart system can include a computing system in communication with the radio-frequency identification reader. The radio-frequency identification reader can be configured to transmit the signal to the computing system. Based on the signal received from the radio-frequency identification reader, the computing system can be configured to transmit a message to at least one portable electronic device in the geographic area including an estimated location of the shopping cart.

In accordance with embodiments of the present disclosure, an exemplary method of assisting a user of a shopping cart is provided. The method includes providing a shopping cart within a geographic area. The shopping cart includes an actuator configured to be selectively actuated between a first position that prevents the radio-frequency identification tag from transmitting the signal from the radio-frequency identification tag and a second position that facilitates transmissions of the signal from the radio-frequency identification tag. The method includes actuating the actuator, by the user, to move the actuator into the second position. In response to actuating the actuator to the second position, the method includes transmitting the signal from the radio-frequency identification tag to at least one radio-frequency identification reader. The method includes receiving the signal by a computing system in communication with the at least one radio-frequency identification reader. The method includes transmitting a message to at least one portable electronic device in the geographic area including an estimated location of the shopping cart.

The method includes identifying a first position and a second position of the shopping cart within the geographic area based on a location of the at least one radio-frequency reader that received the signal transmitted from the radio-frequency identification tag. The method includes transmitting the first position and the second position of the shopping cart to the at least one portable electronic device.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the shopping carts, reference is made to the accompanying figures, wherein:

FIG. 1 is a block diagram of an exemplary shopping cart system of the present disclosure;

FIG. 2 is a diagrammatic perspective view of an exemplary shopping cart of the present disclosure;

FIG. 3 is a diagrammatic perspective view of an exemplary assistance unit of a shopping cart of the present invention in a first position;

FIG. 4 is a diagrammatic perspective view of an exemplary assistance unit of a shopping cart of the present invention in a second position;

FIG. 5 is a diagrammatic side view of an exemplary actuator of an assistance unit of a shopping cart of the present invention in a second position;

FIG. 6 is a diagrammatic perspective view of an exemplary assistance unit of a shopping cart of the present invention in a first position;

FIG. 7 is a diagrammatic perspective view of an exemplary assistance unit of a shopping cart of the present invention in a second position;

FIG. 8 is a diagrammatic perspective view of an exemplary assistance unit of a shopping cart of the present invention in a first position;

FIG. 9 is a diagrammatic perspective view of an exemplary assistance unit of a shopping cart of the present invention in a second position;

FIG. 10 is a diagrammatic front view of an exemplary visual indicator of a shopping cart of the present invention;

FIG. 11 is a diagrammatic perspective view of an exemplary shelf system including a radio-frequency identification reader of the present invention;

FIG. 12 is a block diagram of a computing device in accordance with exemplary embodiments of the present disclosure;

FIG. 13 is a block diagram of an exemplary shopping cart system environment in accordance with embodiments of the present disclosure; and

FIG. 14 is a flowchart illustrating a process implemented by an exemplary shopping cart system in accordance with embodiments of the present disclosure.

### DETAILED DESCRIPTION

It should be understood that the relative terminology used herein, such as “front”, “rear”, “left”, “top”, “bottom”, “vertical”, “horizontal”, “up” and “down” is solely for the purposes of clarity and designation and is not intended to limit embodiments to a particular position and/or orientation. Accordingly, such relative terminology should not be construed to limit the scope of the present disclosure. In addition, it should be understood that the scope of the present disclosure is not limited to embodiments having specific dimensions. Thus, any dimensions provided herein are merely for an exemplary purpose and are not intended to limit the invention to embodiments having particular dimensions.

Exemplary embodiments of the present disclosure provide a shopping cart with an assistance unit. The assistance unit can be activated to generate a communication from the shopping cart to request assistance from an associate without requiring the user of the shopping cart to wait in one location for the associate. In particular, the assistance unit allows the user to continue shopping until the associate locates the user within the geographic area defining the retail establishment. The assistance unit can include an RFID tag that transmits a signal for receipt by one or more RFID readers. The assistance unit further includes an actuator that can be selectively actuated by the user between a first position that prevents the RFID tag from transmitting the signal and a second position that facilitates transmission of the signal from the RFID tag. Based on the received signal from the RFID tag, the appropriate associate can locate the shopping cart within the retail establishment to assist the user of the shopping cart. The user can therefore continue to move with the shopping cart through the retail establishment until the appropriate assistance is provided without waiting on the associate at a specific location in the retail establishment.

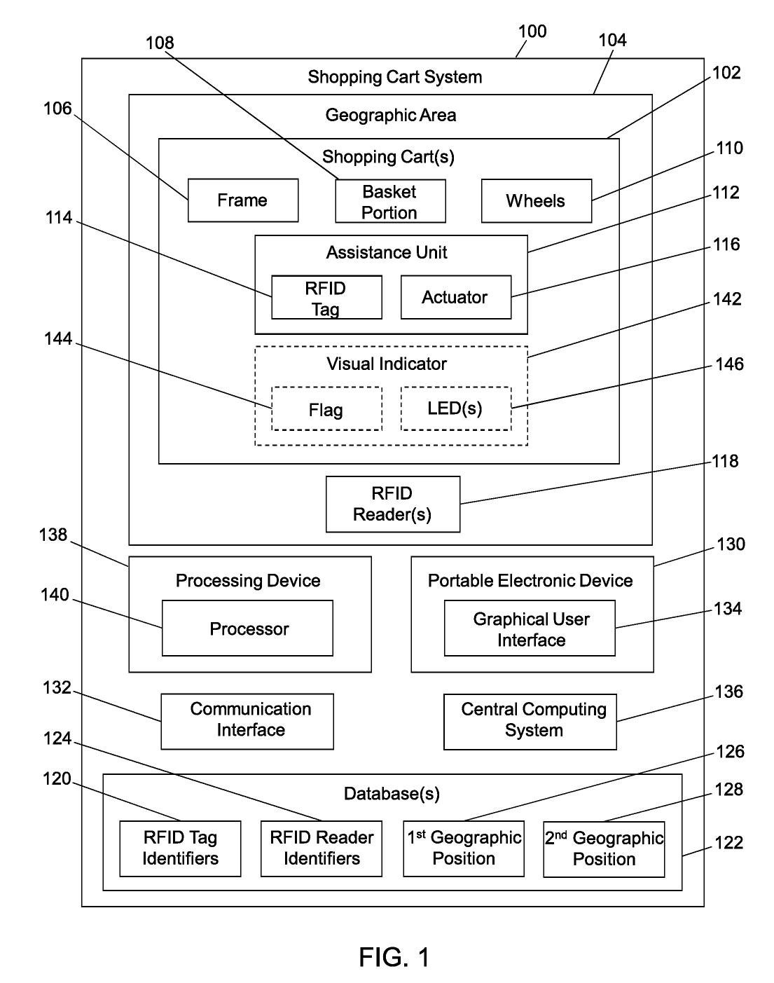

FIG. 1 is a block diagram of an exemplary shopping cart system 100 (hereinafter “system 100”) of the present disclosure. The system 100 generally includes one or more shopping carts 102 disposed within a geographic area 104 (e.g., the retail establishment). The geographic area 104 can include aisles or departments for different categories of products, such as school supplies, sports, groceries, auto parts, electronics, men's clothing, women's clothing, kid's clothing, or the like. In general, the retail establishment has associates specific to each department within the geographic area 104 such that department-specific questions can be answered by appropriate associate.

The shopping cart 102 includes a frame 106, a basket portion 108 mounted to the frame 106, and two or more wheels 110 mounted to the frame 106 for transporting the shopping cart 102 within the geographic area 104. The shopping cart 102 includes an assistance unit 112 mounted to the frame 106 (e.g., the handle). The assistance unit 112 can be selectively actuated by the user to communicate a request for assistance from an associate. In particular, the assistance unit 112 includes an RFID tag 114 and an actuator 116. The RFID tag 114 can be configured to transmit a radio-frequency (RF) signal for receipt by one or more RFID readers 118 disposed within the geographic area 104.

In one embodiment, the RFID tag 114 can continuously or periodically transmit the RF signal and the actuator 116 can be selectively actuated between a first position that prevents the RFID tag 114 from transmitting the RF signal from the assistance unit 112 and a second position that facilitates transmissions of the RF signal from the assistance unit 112. In one embodiment, the assistance unit 112 can include a housing configured to contain therein the RFID tag 114 and the actuator 116. In one embodiment, the actuator 116 can be in the form of a panel that is slidable between the first and second positions. In the first position, the panel covers a window in the housing to prevent the RF signal from the RFID tag 114 from being transmitted out of the housing. In the second position, the panel can at least partially expose the window in the housing through which the RF signal from the RFID tag 114 can be transmitted. In such embodiments, the housing and the panel (or the inner surfaces of the housing and the panel) can be formed from an electromagnetic shielding material to prevent the RF signal from being transmitted out of the housing. In some embodiments, the shopping cart 102 can include a power source (e.g., a battery) that is rechargeable or is chargeable based on the rotational movement of the wheels 110.

In one embodiment, the RFID tag 114 can be configured to receive RF signals from surrounding RFID readers 118. For example, the RFID tag 114 can be a passive RFID tag 114 and the actuator 116 prevents transmission of the RF signal by the RFID tag 114 in the first position by shielding the RFID tag 114 from transmissions emitted by the RFID readers 118 (e.g., the housing prevents transmissions emitted by the RFID readers 118 from entering the housing and being received by the RFID tag 114).

In one embodiment, the actuator 116 can be in the form of an electrical switch. Actuating the actuator 116 into the second position can create an electrical contact between electrical components sufficient to permit the RFID tag 114 to transmit the RF signal to the RFID readers 118. In some embodiments, the RF signal transmitted by the RFID tag 114 has a maximum range of, e.g., a radius of approximately five feet, or the like, such that only RFID readers 118 in the vicinity of the shopping cart 102 receive the transmitted RF signal.

In one embodiment, the RFID tag 114 can be a near-field RFID tag 114 and the actuator 116 can include a far-field component. In such embodiments, actuation of the actuator 116 into the second position places the near-field RFID tag 114 into operable proximity of the far-field component. Placing the near-field RFID tag 114 into operable proximity of the far-field component allows the near-field RFID tag 114 to transmit the RF signal to the RFID reader 118 via the far-field component. In one embodiment, the far-field component can be a far-field antenna.

Each shopping cart 102 can include an RFID tag 114 having a unique identifier 120 (e.g., an alphanumeric value) to allow for differentiation between the shopping carts 102 within the geographic area 104. The RFID tag identifiers 120 can be electronically stored in one or more databases 122 of the system 100. Each RFID reader 118 can also have a unique identifier 124 (e.g., an alphanumeric value) to allow for differentiation between the RFID readers 118 within the geographic area 104 and for identification of the geographic position of each RFID reader 118 within the geographic area 104. The RFID reader identifiers 124 can be electronically stored in one or more databases 122 of the system 100.

The RF signal transmitted from the RFID tag 114 and/or the RF signal transmitted from the RFID reader 118 to the RFID tag 114 can be used to identify first and second geographic positions 126, 128 of the shopping cart 102 within the geographic area 104. The first geographic position 126 of the shopping cart 102 can correspond to a position of the shopping cart 102 within the geographic area 104 when the actuator 116 was initially actuated into the second position. For example, if a user is in the electronics department and requires assistance, the actuator 116 can be actuated into the second position and, based on the RF signal from the RFID tag 114 received by one or more of the nearest RFID readers 118, the first geographic position 126 of the shopping cart 102 can be identified as the electronics department. The first geographic position 126 can include information regarding the type of department, the aisle, and the bin when the actuator 116 was actuated into the second position. The first geographic position 126 can be stored in the database 122.

Upon identification of the first geographic position 126 of the shopping cart 102, the first geographic position 126 and the RFID tag identifier 120 associated with the shopping cart 102 is electronically transmitted to a portable electronic device 130 of one or more associates via a communication interface 132. The portable electronic device 130 can be specific to an associate who can assist with questions relating to items located in the department corresponding to the first geographic position 126 of the shopping cart 102. The portable electronic device 130 can include a graphical user interface (GUI) 134 for receiving the assistance request from the shopping cart 102. If two or more portable electronic devices 130 receive the transmitted request for assistance, the first associate capable of providing assistance can indicate via the GUI 134 that assistance will be provided by them, thereby preventing multiple associates responding to a single request.

In one embodiment, the system 100 includes a central computing system 136 in communication with the RFID reader 118 via the communication interface 132. The RFID reader 118 can be configured to transmit the signal to the central computing system 136 and, based on the signal received from the RFID reader 118, the central computing system 136 can be configured to transmit an electronic message to one or more portable electronic devices 130 in the geographic area 104 including the estimated location of the shopping cart 102 (e.g., the first geographic position 126). In some embodiments, triangulation based on multiple RFID readers 118 receiving the RF signal from the RFID tag 114 can be used to estimate the geographic position of the shopping cart 102 at the first geographic position 126. In some embodiments, the system 100 can include a processing device 138 including a processor 140 configured to operate in cooperation with the central computing system 136, the portable electronic device 130, and/or the communication interface 132 to determine and transmit the position of the shopping cart 102 within the geographic area 104.

The second geographic position 128 of the shopping cart 102 corresponds with the estimated current position of the shopping cart 102 within the geographic area 104. Rather than having the user wait in the department associated with the first geographic position 126 until the associate comes to assist, the user can actuate the actuator 116 into the second position within the geographic area 104. Therefore, the user can travel from the department corresponding with the first geographic position 126 to a different department. As the shopping cart 102 travels within the geographic area 104, the surrounding RFID readers 118 continue to receive the RF signal from the RFID tag 114. Based on the substantially continuous detection of the RF signal, the RFID readers 118 track the position of the shopping cart 102 within the geographic area 104 after the actuator 116 has been actuated into the second position.

For example, if the user was in the electronics department when the actuator 116 was actuated into the second position and has now traveled to the men's clothing department (e.g., the second geographic position 128), the estimated location of the user can be transmitted to the portable electronic device 130. In some embodiments, the estimated current position of the user within the geographic area 104 can be continuously transmitted to the portable electronic device 130 in real-time via the communication interface 132 and/or the central computing system 136 such that the associate can monitor the location of the user after the assistance request has been transmitted. Thus, when the associate is capable of providing assistance to the user, the associate can travel to the second geographic position 128 of the shopping cart 102. In one embodiment, the second geographic position 128 of the shopping cart 102 can be used by the central computing system 136 to estimate the direction of travel of the user within the geographic area 104, thereby estimating where the user will be in the geographic area 104 at a future time in order to send an associate to the proper location within the geographic area 104. For example, if the user is traveling in the direction of the electronics area, the associate can be sent to the electronics area to meet the user and provide assistance to the user.

In one embodiment, as the associate approaches the second geographic position 128 detected for the shopping cart 102 (e.g., the current geographic location of the shopping cart), the portable electronic device 130 can be used to detect the RF signal from the shopping cart 102 based on the unique RFID tag identifier 120. In one embodiment, the shopping cart 102 can include one or more visual indicators 142 mounted to the frame 106 or the basket portion 108 to provide visual feedback when the actuator 116 is actuated into the second position. The visual indicator 142 can thereby provide visual feedback to the associate arriving to the second geographic position 128 regarding which shopping cart 102 requested assistance at the first geographic position 126.

In one embodiment, the visual indicator 142 can be in the form of a flag 144 with a unique number and/or color. In one embodiment, the visual indicator 142 can be in the form of one or more light emitting diodes (LEDs) 146. The LEDs 146 can display a unique illumination color and/or pattern to identify the shopping cart 102 that requested assistance at the first geographic position 126. In one embodiment, the LEDs 146 can display one illumination color and/or pattern upon actuation of the actuator 116 into the second position, and display a second illumination color and/or pattern when the associate with the portable electronic device 130 is within a predetermined distance (e.g., five feet) of the shopping cart 102. Upon receiving assistance from the associate, the actuator 116 can be actuated into the first position to prevent further transmission of the RF signal from the RFID tag 114.

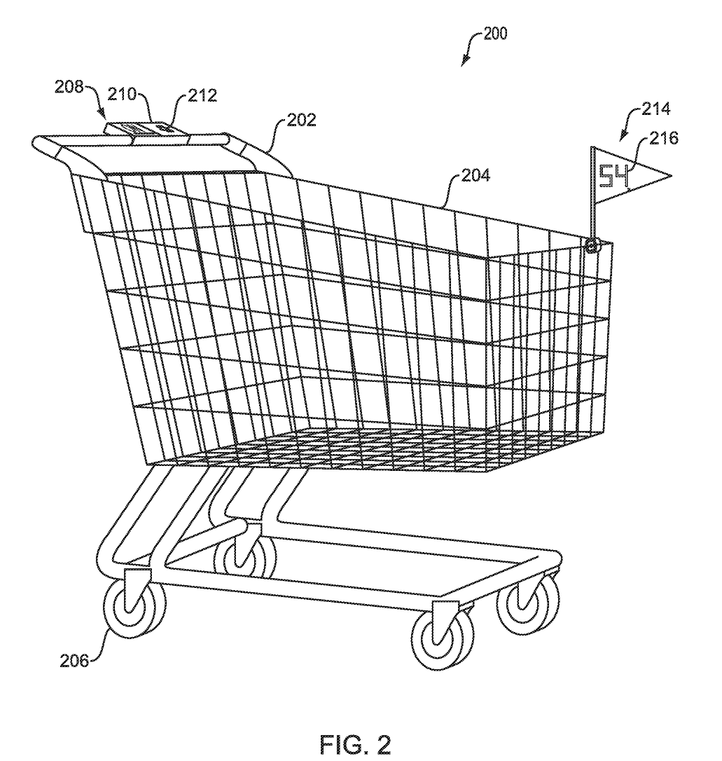

FIG. 2 is a diagrammatic perspective view of an exemplary shopping cart 200 of the present disclosure. The shopping cart 200 includes a frame 202, a basket portion 204 mounted to the frame 202, and two or more wheels 206 mounted to the frame 202. The shopping cart 200 includes an assistance unit 208 mounted to the frame 202 (e.g., the handle portion of the frame 202) such that the user can actuate the assistance unit 208 to request help from an associate. The assistance unit 208 includes a housing 210 and an actuator 212 (e.g., a slidable panel, a hinged lid, or the like) that can be selectively actuated between a first and second position.

In some embodiments, the shopping cart 200 can include a visual indicator 214 for providing visual feedback to the associate when locating the shopping cart 202 in the geographic area. In one embodiment, the visual indicator 214 can be in the form of a flag including a display area 216. The display area 216 can include one or more LEDs configured to display a unique color, a unique illumination pattern, a unique identification number, combinations thereof, or the like.

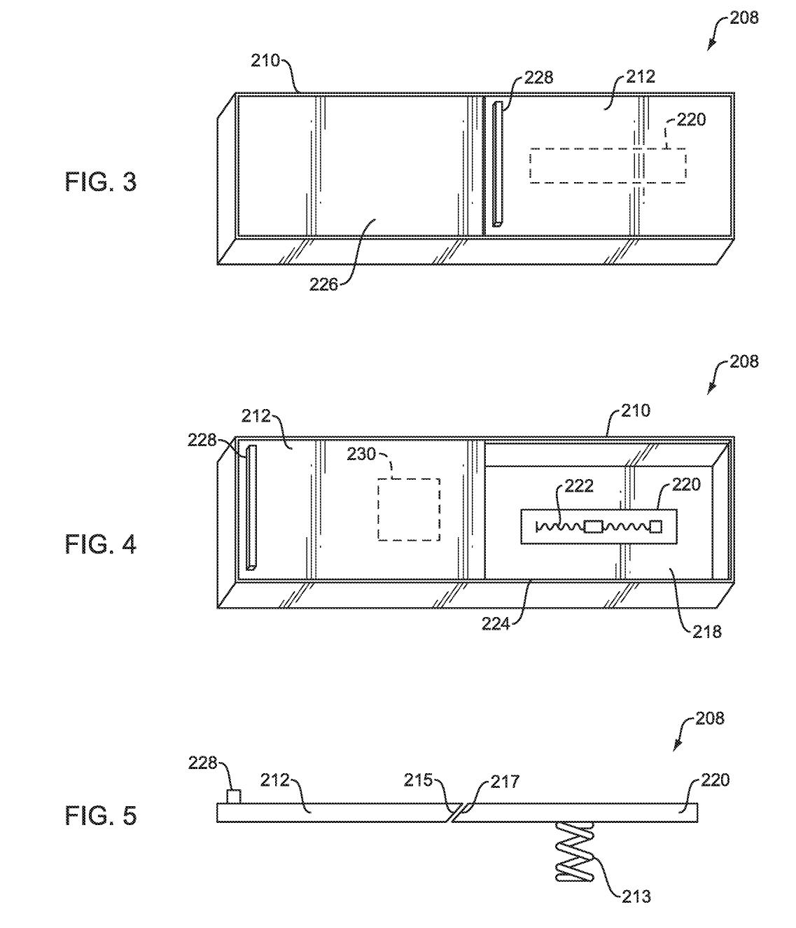

FIGS. 3-5 are diagrammatic perspective views of the assistance unit 208. In particular, FIG. 3 shows the assistance unit 208 with the actuator 212 in the first position (e.g., a closed position), FIG. 4 shows the assistance unit 208 with the actuator 212 in the second position (e.g., an open position), and FIG. 5 shows a side view of the actuator 212 in the second position. The housing 210 defines an enclosure 218 in which the RFID tag 220 is positioned. The RFID tag 220 includes circuitry 222 configured to transmit an RF signal (e.g., continuously, at a predetermined frequency, or the like).

The housing 210 includes an opening or window 224 on one side of the housing 210 and solid, enclosed structure 226 on the opposing side of the housing 210. The actuator 212 defines a substantially planar, slidable panel configured to cover the window 224 in its entirety when actuated into the first position (e.g., FIG. 3). In one embodiment, the housing 210 and the actuator 212 can be fabricated from an electromagnetic shielding material to prevent transmission of RF signals from the assistance unit 208 when the actuator 212 is in the first position. In one embodiment, the housing 210 and the actuator 212 can include inner surfaces covered or coated with an electromagnetic shielding material to prevent transmission of RF signals from the assistance unit 208. In some embodiments, the inner surface of the enclosure 218 can be of a bright color as compared to the outer surface of the housing 210 to provide the user with a visual indication that the actuator 212 has been positioned in the second position.

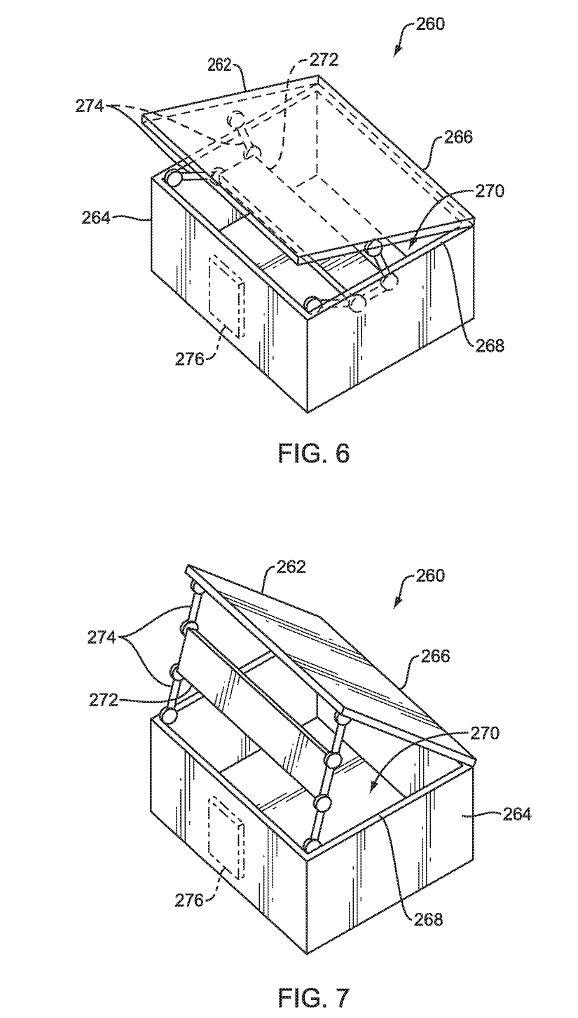

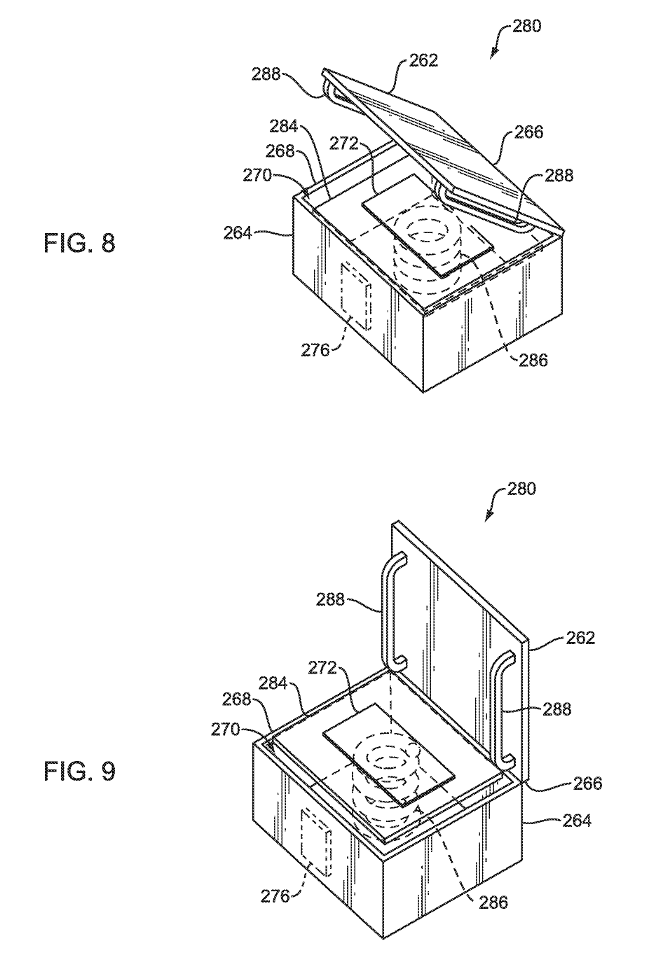

The actuator 212 can include a raised edge 228 to provide a gripping surface for imparting a force on the actuator 212 to slide the actuator 212 between the first and second positions. In the second position, the actuator 212 is slid to at least partially expose the window 224, thereby allowing the RF signals from the RFID tag 220 to be transmitted out of the enclosure 218 (e.g., FIG. 4). In one embodiment, the assistance unit 208 can include a lifting assembly (e.g., one or more connecting elements shown in FIGS. 6 and 7, a spring mechanism shown in FIGS. 8 and 9, or the like) for at least partially lifting the RFID tag 220 out of the housing 210 and above the plane defined by the window 224.

For example, as shown in FIG. 5, the assistance unit 208 can include a spring 213 coupled to the bottom of the RFID tag 220 and the inner surface of the housing 210. In such embodiment, sliding the actuator 212 into the second position allows the spring 213 to expand and at least partially lifts the RFID tag 220 out of the window 224. The edges 215, 217 of the actuator 212 and the RFID tag 220 can be angled to form a ramp such that sliding the actuator 212 against the edge 217 forces the RFID tag 220 into the window 224, thereby compressing the spring 213 and allowing the RFID tag 220 to be enclosed within the housing 210.

In one embodiment, the actuator 212 can function as an electrical switch such that positioning the actuator 212 in the second position completes an electrical circuit with the circuitry 222 of the RFID tag 220, thereby permitting the RFID tag 220 to transmit the RF signal. In one embodiment, the RFID tag 220 can be a near-field RFID tag 220 and the actuator 212 can include a far-field component 230. With the actuator 212 in the second position, the window 224 is exposed and the far-field component 230 is positioned into operable proximity of the near-field RFID tag 220, allowing the RFID tag 220 to transmit the RF signal to the RF receiver view the far-field component 230 (e.g., an antenna).

FIGS. 6 and 7 are diagrammatic perspective views of an assistance unit 260 including an actuator 262 in the form of a hinged lid. In particular, FIG. 6 shows the assistance unit 260 with the actuator 262 in a partially first position (e.g., a partially closed position), and FIG. 7 shows the assistance unit 260 with the actuator 262 in the second position (e.g., an open position). The assistance unit 260 includes a housing 264 with a lid (e.g., actuator 262) hingedly attached to the housing 264 along a point or edge 266. The lid can therefore be selectively opened or closed to expose an opening 268 in the housing leading to an enclosure 270 in which an RFID tag 272 is movably positioned or suspended. In some embodiments, the assistance unit 260 can include a depressible button 276 for selectively regulating opening and closing the actuator 262.

The assistance unit 262 includes one or more connecting elements 274 (e.g., strings, plastic hinges, or the like that form a lifting assembly) that connect the RFID tag 272 to the actuator 262 and the housing 264. The connecting elements 274 can be fabricated from an RF-neutral material to prevent interference with the RF signal from the RFID tag 272. In some embodiments, one or more connecting elements 274 can connect one side or edge of the RFID tag 272 to the actuator 262, and one or more connecting elements 274 can connect the opposing side or edge of the RFID tag 272 to the inner portion or perimeter edge of the housing 264.

In the fully closed position (e.g., a first position) in which the actuator 262 substantially fully closes the opening 268, the connecting elements 274 lower the RFID tag 272 into the enclosure 270 below the plane defined by the opening 268. Thus, in the first position, the RFID tag 272 is surrounded or enclosed by the housing 264 and the actuator 262, preventing RF signals of the RFID tag 272 from being transmitted out of the assistance unit 260.

As the actuator 262 is opened (e.g., partially opened as shown in FIG. 6 and fully opened as shown in FIG. 7), the connecting elements 274 tighten and at least partially lift the RFID tag 272 out of the enclosure 270 and above the plane defined by the opening 268. Particularly, as the distance between the actuator 262 and the opening 268 increases during opening of the lid, the RFID tag 272 is lifted or elevated out of the housing 264. Such lifting of the RFID tag 272 out of the housing 264 increases the exposure of the RFID tag 272 by limiting the structures surrounding the RFID tag 272, thereby improving the RF signal strength and range from the RFID tag 272. In some embodiments, RF foam can be used below and/or around the RFID tag 272 to improve the RF signal strength from the RFID tag 272.

FIGS. 8 and 9 are diagrammatic perspective views of an assistance unit 280. The assistance unit 280 can be substantially similar in structure and function to the assistance unit 260, except for the distinctions noted herein. Therefore, like reference numbers are used to refer to like structures. Rather than or in addition to the connecting elements 274, the assistance unit 280 includes a lifting assembly 282 for lifting or elevating the RFID tag 272 from the housing 264. The lifting assembly 282 can be fabricated from an RF neutral material to prevent interference with the RF signal from the RFID tag 272.

The lifting assembly 282 can include a pad or support 284 on which the RFID tag 272 is mounted. In some embodiments, the support 284 can be fabricated from RF foam. The lifting assembly 282 includes a spring 286 (or any other lifting, biasing, or expansion element) coupled at one end to the inner surface of the housing 264 and coupled at the opposing end to the bottom of the support 284. In some embodiments, rather than including the support 284, the spring 286 can be coupled directly to the RFID tag 272. In some embodiments, the assistance unit 280 can include one or more guiding rails or tracks 288. The tracks 288 can extend along the inner surface of the actuator 262.

In the fully closed position (e.g., a first position) in which the actuator 262 substantially fully closes the opening 268, the tracks 288 engage the support 284 and assist in compressing the spring 286 to lower the RFID tag 272 into the enclosure 270 below the plane defined by the opening 268. Thus, in the first position, the RFID tag 272 is surrounded or enclosed by the housing 264 and the actuator 262, preventing RF signals of the RFID tag 272 from being transmitted out of the assistance unit 280.

As the actuator 262 is opened (e.g., partially opened as shown in FIG. 8 and fully opened as shown in FIG. 9), the spring 286 expands and at least partially lifts the RFID tag 272 out of the enclosure 270 and above the plane defined by the opening 268. Particularly, as the angle between the actuator 262 and the opening 268 increases during opening of the lied, the RFID tag 272 is lifted or elevated out of the housing 264. Such lifting of the RFID tag 272 out of the housing 264 increases the exposure of the RFID tag 272 relative to the housing 264, thereby improving the RF signal strength and range from the RFID tag 272.

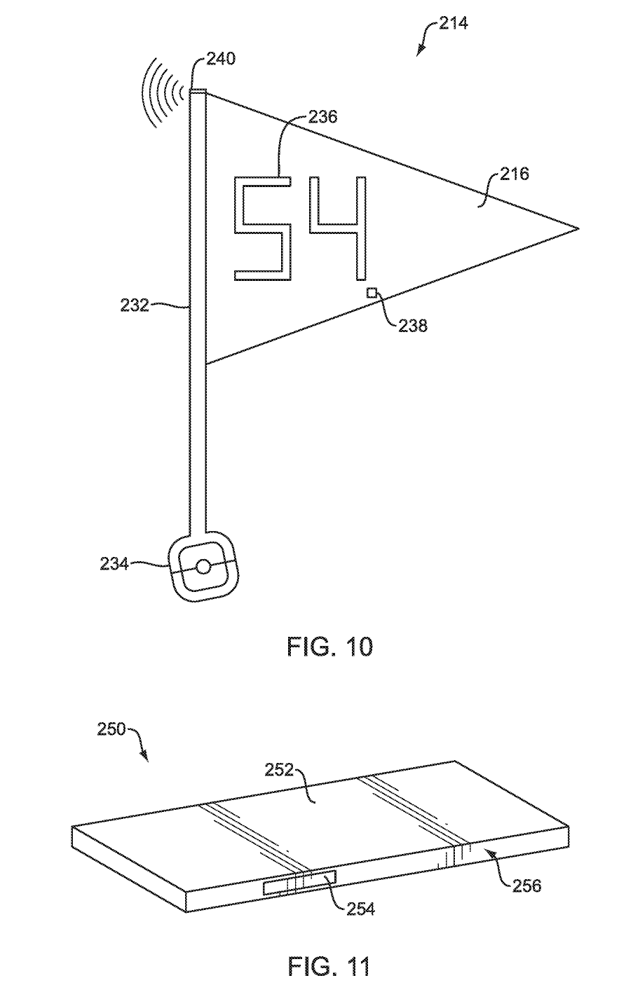

FIG. 10 is a diagrammatic front view of the visual indicator 214 of the shopping cart 200. The visual indicator 214 can be in the form of a flag, including a pole 232 and the display area 216 secured to the pole 232. The pole 232 can be mounted to the frame 202 via a swivel mechanism 234. The swivel mechanism 234 can be used to reposition the visual indicator 214 to face in the desired direction relative to the frame 202 and/or can be used to fold the visual indicator 214 into a stored position (e.g., folded into the basket portion 204) and an extended position (e.g., shown in FIG. 2). In some embodiments, positioning the visual indicator 214 into the extended position can act as the actuator for the assistance unit 208 with the stored position corresponding to the first position of the actuator and the extended position corresponding with the second position of the actuator.

In some embodiments, the display area 216 can include a unique identifier 236 (e.g., an alphanumeric value, a color, combinations thereof, or the like) to distinguish the shopping cart 200 from other shopping carts 200 in the geographic area. In some embodiments, the display area 216 includes one or more LEDs 238 configured to illuminate in one or more unique colors and/or illumination patterns to identify the shopping cart 200. In some embodiments, the visual indicator 214 can include an antenna 240 for transmitting RF signals from the visual indicator 214 when the visual indicator 214 is in the extended position. In some embodiments, the antenna 240 can be used to communicate with the RFID tag 220 such that the colors of the LEDs 238 are adjusted based on the status of the requested assistance (e.g., red when the user initially requests assistance, yellow when the associate has read the transmitted message, and green when the associate is on the way to the shopping cart 200 to provide assistance). In some embodiments, a central server can communicate with the visual indicator 214 to adjust the colors of the LEDs 238 based on the status of the requested assistance.

FIG. 11 is a diagrammatic perspective view of an exemplary shelf system 250 of the geographic area. The geographic area can include multiple shelf systems 250 distributed within the geographic area to assist in tracking the location of the shopping cart 200 within the geographic area. The shelf system 250 includes a shelf 252 with one or more RFID readers 254 mounted to the shelf 252. In one embodiment, the RFID reader 254 can be mounted to the front face 256 of the shelf 252. Although illustrated as mounted to a shelf 252, it should be understood that the RFID readers 254 can be mounted to other structures within the geographic area, e.g., racks, ceilings, walls, doors, or the like. The RFID readers 254 can be configured to detect the RF signals transmitted from the RFID tag 220 to determine the location in which the user requested assistance and the estimated real-time location of the shopping cart 200 within the geographic area.

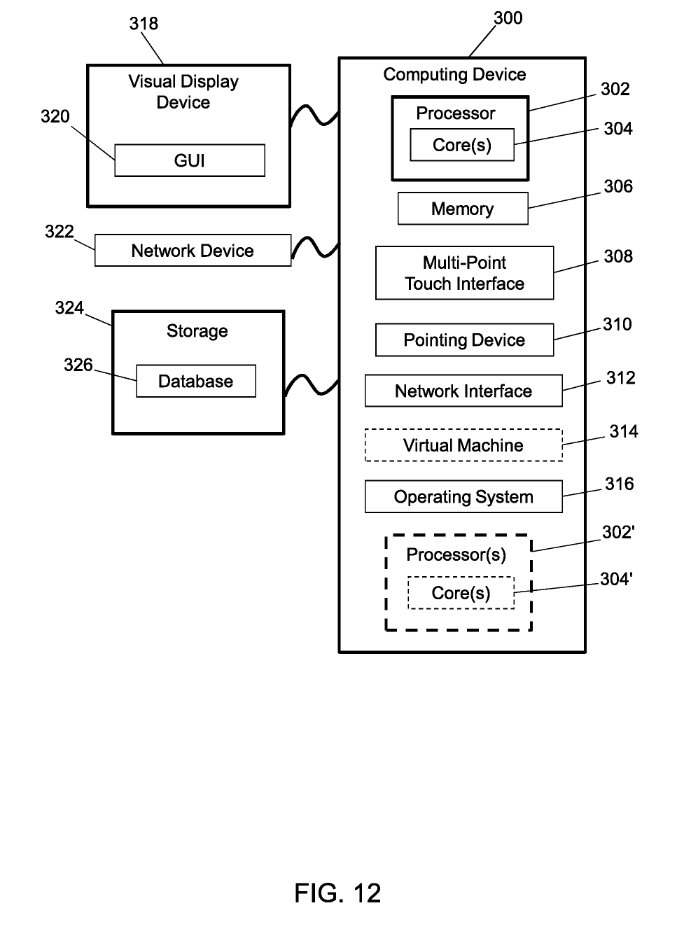

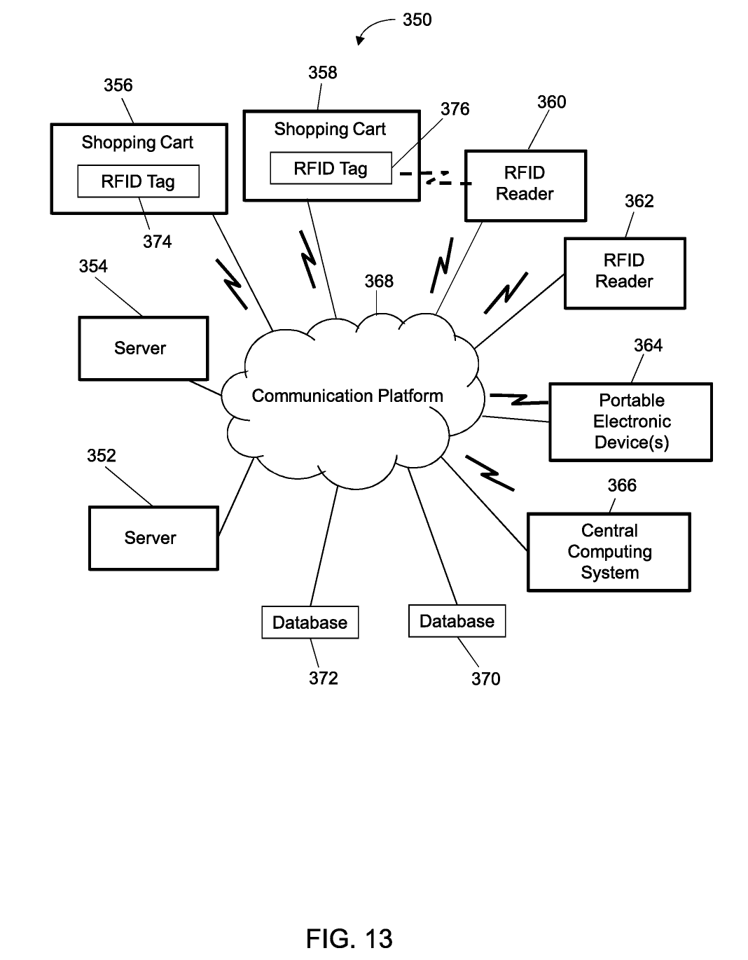

FIG. 12 is a block diagram of a computing device 300 in accordance with exemplary embodiments of the present disclosure. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions or software for implementing exemplary embodiments of the present disclosure (e.g., instructions for operating the RFID tag 114, instructions for operating the RFID reader 118, instructions for operating the processing device 138, instructions for operating the portable electronic device 130, instructions for operating the communication interface 132, instructions for operating the central computing system 136, combinations thereof, or the like). The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device 300 may be shared dynamically. A virtual machine 314 may be provided to handle a process running on multiple processors so that the process appears to be using only one computing resource rather than multiple computing resources. Multiple virtual machines may also be used with one processor. Memory 306 may include a computer system memory or random access memory, such as DRAM, SRAM, EDO RAM, and the like. Memory 306 may include other types of memory as well, or combinations thereof.

A user may interact with the computing device 300 through a visual display device 318 (e.g., a personal computer, a mobile smart device, or the like), such as a computer monitor, which may display one or more user interfaces 320 (e.g., GUI 134) that may be provided in accordance with exemplary embodiments. The computing device 300 may include other I/O devices for receiving input from a user, for example, a keyboard or any suitable multi-point touch interface 308, a pointing device 310 (e.g., a mouse). The keyboard 308 and the pointing device 310 may be coupled to the visual display device 318. The computing device 300 may include other suitable conventional I/O peripherals.

The computing device 300 may also include one or more storage devices 324, such as a hard-drive, CD-ROM, or other computer readable media, for storing data and computer-readable instructions and/or software that implement exemplary embodiments of the system 100 described herein. Exemplary storage device 324 may also store one or more databases 326 for storing any suitable information required to implement exemplary embodiments. For example, exemplary storage device 324 can store one or more databases 326 for storing information, such as data relating to RFID tag identifiers 120, RFID reader identifiers 124, the first geographic position 126, the second geographic position 128, combinations thereof, or the like, and computer-readable instructions and/or software that implement exemplary embodiments described herein. The databases 326 may be updated by manually or automatically at any suitable time to add, delete, and/or update one or more items in the databases.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 300 may run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 316 may be run in native mode or emulated mode. In an exemplary embodiment, the operating system 316 may be run on one or more cloud machine instances.

FIG. 13 is a block diagram of an exemplary shopping cart system environment 350 in accordance with exemplary embodiments of the present disclosure. The environment 350 can include servers 352, 354 configured to be in communication with shopping carts 356, 358 including RFID tags 374, 376, and RFID readers 360, 362, via a communication platform 368, which can be any network over which information can be transmitted between devices communicatively coupled to the network. For example, the communication platform 368 can be the Internet, Intranet, virtual private network (VPN), wide area network (WAN), local area network (LAN), and the like. In some embodiments, the communication platform 368 can be part of a cloud environment. The environment 350 can include portable electronic devices 364 and central computing systems 366, which can be in communication with the servers 352, 354, as well as the shopping carts 356, 358 and RFID readers 360, 362, via the communication platform 368. The environment 350 can include repositories or databases 370, 372, which can be in communication with the servers 352, 354, as well as the shopping carts 356, 358, the RFID readers 360, 362, the portable electronic devices 364 and the central computing systems 366, via the communications platform 368.

In exemplary embodiments, the servers 352, 354, shopping carts 356, 358, RFID readers 360, 362, portable electronic devices 364, central computing systems 366, and databases 370, 372 can be implemented as computing devices (e.g., computing device 300). Those skilled in the art will recognize that the databases 370, 372 can be incorporated into one or more of the servers 352, 354 such that one or more of the servers 352, 354 can include databases 370, 372. In some embodiments, the database 370 can store the RFID tag identifiers 120 and the RFID reader identifiers 124, and the database 372 can store the first and second geographic positions 126, 128. In some embodiments, a single database 370, 372 can store the RFID tag identifiers 120, the RFID reader identifiers 124, and the first and second geographic positions 126, 128.

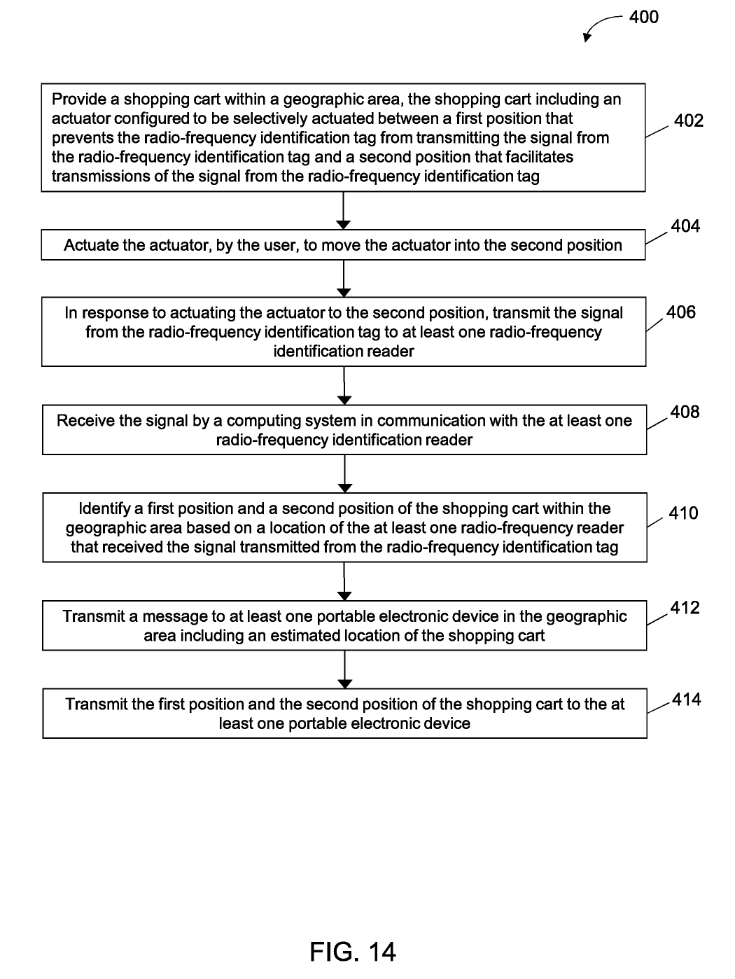

FIG. 14 is a flowchart illustrating an exemplary process 400 as implemented by embodiments of the shopping cart system 100. To begin, at step 402, a shopping cart is provided within a geographic area. The shopping cart includes an actuator configured to be selectively actuated between a first position that prevents the RFID tag from transmitting the signal from the RFID tag and a second position that facilitates transmissions of the signal from the RFID tag. At step 404, the actuator is actuated by the user to move the actuator from the first position to the second position. In some embodiments, moving the actuator into the second position at least partially lifts the RFID tag from the housing of the assistance unit. At step 406, in response to actuating the actuator to the second position, the RFID tag transmits the signal to at least one RFID reader.

At step 408, the signals from the RFID tag are received by a computing system in communication with the at least one RFID reader. At step 410, a first and second position of the shopping cart within the geographic area are identified based on a location of the at least one RFID reader that received the signal transmitted from the RFID tag. The first position of the shopping cart can correspond to the location at which the actuator was actuated to the second position and the second position of the shopping cart can correspond to current location of the shopping cart in the geographic area. At step 412, a message is electronically transmitted to at least one portable electronic device in the geographic area including an estimated location of the shopping cart within the geographic area. At step 414, the first and second positions of the shopping cart are transmitted to the at least one portable electronic device. The message can be transmitted by a computing system that received the signal from the RFID tag via one or more of the RFID readers.

Thus, the exemplary shopping cart provides an assistance unit that can be actuated to request assistance in a specific department within the geographic area. The assistance unit allows the user to continue traveling within the geographic area through different departments and includes a communication system that provides an associate with substantially real-time tracking of the position of the shopping cart within the geographic area. The assistance unit advantageously provides the user with assistance from the appropriate associate familiar with the department in question, and allows the user to continue shopping until assistance is available. The user experience within the geographic area is therefore improved by allowing the user to continue shopping without losing time waiting on the associate.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A shopping cart, comprising:
a frame;
a basket portion mounted to the frame;
two or more wheels mounted to the frame for transporting the shopping cart within a geographic area; and
an assistance unit mounted to the frame, the assistance unit including:
a radio-frequency identification tag configured to transmit a signal for receipt by a radio-frequency identification reader; and
an actuator configured to be selectively actuated between a first position that prevents the radio-frequency identification tag from transmitting the signal from the assistance unit and a second position that facilitates transmissions of the signal from the assistance unit.

2. The shopping cart of claim 1, wherein the assistance unit comprises a housing configured to contain therein the radio-frequency identification tag and the actuator, wherein the actuator is a panel that is slidable between the first position and the second position.

3. The shopping cart of claim 2, wherein:
in the first position, the panel covers a window in the housing to prevent the signal from the radio-frequency identification tag from being transmitted out of the housing; and
in the second position, the panel exposes the window in the housing through which the signal from the radio-frequency identification tag is transmitted.

4. The shopping cart of claim 2, wherein the housing and the panel are formed of an electromagnetic shielding material.

5. The shopping cart of claim 1, wherein the radio-frequency identification tag is a passive radio-frequency identification tag, and the actuator prevents transmission of the signal by the radio-frequency identification tag in the first position by shielding the radio-frequency identification tag from transmissions emitted by the radio-frequency identification reader.

6. The shopping cart of claim 1, wherein the actuator comprises a switch, and wherein actuating the actuator into the second position creates an electrical contact sufficient to permit the radio-frequency identification tag to transmit the signal to the radio-frequency reader.

7. The shopping cart of claim 1, wherein:
the radio-frequency identification tag is a near-field radio-frequency identification tag, and the actuator includes a far-field component;
actuation of the actuator into the second position places the near-field radio-frequency identification tag into operable proximity of the far-field component, and the near-field radio-frequency identification tag transmits the signal to the radio-frequency reader via the far-field component; and
the far-field component comprises a far-field antenna.

8. The shopping cart of claim 1, comprising a visual indicator mounted to the frame or the basket portion, the visual indicator providing visual feedback when the actuator is actuated into the second position.

9. The shopping cart of claim 1, wherein the assistance unit comprises a housing and a lifting assembly, and actuating the actuator into the second position at least partially lifts the radio-frequency identification tag out of the housing with the lifting assembly.

10. The shopping cart of claim 9, wherein the lifting assembly includes connecting elements suspending the radio-frequency identification tag between the housing and the actuator, or a spring biasing the radio-frequency identification tag out of the housing.

11. A shopping cart system, comprising:
a radio-frequency identification reader disposed within a geographic area; and
a shopping cart disposed within the geographic area, the shopping cart including:
a frame;
a basket portion mounted to the frame;
two or more wheels mounted to the frame for transporting the shopping cart within the geographic area; and
an assistance unit mounted to the frame, the assistance unit including:
a radio-frequency identification tag configured to transmit a signal for receipt by the radio-frequency identification reader; and
an actuator configured to be selectively actuated between a first position that prevents the radio-frequency identification tag from transmitting the signal from the assistance unit and a second position that facilitates transmissions of the signal from the assistance unit.

12. The system of claim 11, wherein based on the signal from the radio-frequency identification tag, the radio-frequency identification reader is used to identify a first geographic position and a second geographic position of the shopping cart within the geographic area.

13. The system of claim 11, wherein the radio-frequency identification reader transmits the first geographic position and the second geographic position of the shopping cart to a portable electronic device.

14. The system of claim 11, wherein the first geographic position of the shopping cart corresponds with a position of the shopping cart within the geographic area when the actuator was initially actuated into the second position.

15. The system of claim 11, wherein the second geographic position of the shopping cart corresponds with a current geographic position of the shopping cart within the geographic area.

16. The system of claim 11, comprising a plurality of radio-frequency identification readers disposed within the geographic area, the plurality of radio-frequency identification readers tracking a geographic position of the shopping cart within the geographic area after the actuator has been actuated into the second position.

17. The system of claim 11, further comprising a computing system in communication with the radio-frequency identification reader,
wherein the radio-frequency identification reader is configured to transmit the signal to the computing system, and
wherein, based on the signal received from the radio-frequency identification reader, the computing system is configured to transmit a message to at least one portable electronic device in the geographic area including an estimated location of the shopping cart.

18. A method of assisting a user of a shopping cart, comprising:
providing a shopping cart within a geographic area, the shopping cart including an actuator configured to be selectively actuated between a first position that prevents a radio-frequency identification tag from transmitting the signal from the radio-frequency identification tag and a second position that facilitates transmissions of the signal from the radio-frequency identification tag;
actuating the actuator, by the user, to move the actuator into the second position;
in response to actuating the actuator to the second position, transmitting the signal from the radio-frequency identification tag to at least one radio-frequency identification reader;
receiving the signal by a computing system in communication with the at least one radio-frequency identification reader;
transmitting a message to at least one portable electronic device in the geographic area including an estimated location of the shopping cart.

19. The method of claim 18, comprising identifying a first position and a second position of the shopping cart within the geographic area based on a location of the at least one radio-frequency reader that received the signal transmitted from the radio-frequency identification tag.

20. The method of claim 19, comprising transmitting the first position and the second position of the shopping cart to the at least one portable electronic device.
